(19) United States
(12) Patent Application Publication
(10) Pub. No.: US 2025/0203719 A1
(43) Pub. Date: Jun. 19, 2025

(54) Deployable Heater

(71) Applicant: L'Garde, Inc., Tustin, CA (US)

(72) Inventors: Jack Garcia, Newport Beach, CA (US); Michael Gattulli, Costa Mesa, CA (US)

(21) Appl. No.: 19/064,571

(22) Filed: Feb. 26, 2025

Related U.S. Application Data
(63) Continuation of application No. PCT/US2023/073484, filed on Sep. 5, 2023.
(60) Provisional application No. 63/274,470, filed on Nov. 1, 2021.

(51) Int. Cl. H05B 3/06; H05B 3/40

(52) U.S. Cl. CPC H05B 3/06; H05B 3/40

(57) ABSTRACT

A heating system and method provides a compact storage configuration that can deploy to a deployed configuration to heat an environment, structure, component, etc. The heating system may include a heating source, frame, and deployment device, and power cords, The deployment device may be configured to deploy the system from the stowed configuration to the deployed configuration while reducing stresses on the cords and other system components.

### PRIORITY

The instant application claims priority as a continuation to International Application PCT/US2023/073484, filed Sep. 5, 2023, published as WO 2024/050566, which claims priority to U.S. Application 63/274,470, filed Sep. 2, 2022, each of which are incorporated herein by reference in their entirety.

### BACKGROUND

Heaters may be used in space to increase or change the temperature of a part. The temperature change of a part may be for many reasons, such as to deploy a structure, change a shape of a structure, warm a component part for operation, etc. However, heaters conventionally add weight, size, and complexity to the system design that is adverse to the system because space and weight requirements for space applications are very limited.

### SUMMARY

Systems and methods are described herein for providing heat.

A heating system and method is provided herein that provides a compact storage configuration that can deploy to a deployed configuration to heat an environment, structure, component, etc. The heating system may include a heating source, frame, and deployment device, and power cords, The deployment device may be configured to deploy the system from the stowed configuration to the deployed configuration while reducing stresses on the cords and other system components.

Exemplary embodiments described herein include a heating system for providing heat to a system environment or system part(s). Exemplary embodiments described herein may include a heating source for providing heat, a frame for protecting the heating source, a tether to manage deployment of the heating source, power attachment to power the heating source, and a combination thereof. Exemplary embodiments may also include a retainer for retaining the power attachments and cords that may be used if a plurality of power sources are provided within the system according to exemplary embodiments described herein.

Exemplary systems provided herein include a heating source; a frame coupled to the heating source; and a deployment device coupled to the frame.

Exemplary embodiments of the system may also include a power attachment to the heating source and coupled to the frame, wherein the deployment device is a tether that may be coupled to the frame separate from the power attachment. The tether may be rigidly attached to the frame such that the tether and the frame are not configured to move relative therebetween at the point of attachment. The power cord may be movably attached to the frame such that the power cords and/or other system components and the frame may move relative therebetween at the point of attachment.

In an exemplary embodiment, the frame circumscribes the heating source to provide protection from more than one direction of the heating source.

In an exemplary embodiment, the frame comprises a generally planar component having an aperture therein, the heating source positioned within the aperture such that the frame circumscribes the heating source.

In an exemplary embodiment, the system may include a plurality of heating sources and a plurality of frames, wherein each of the plurality of heating sources each having its own respective frame from the plurality of frames, wherein the tether couples to each of the plurality of frames of each of the plurality of heating sources creating a link between the plurality of heating sources.

In an exemplary embodiment, each of the plurality of frames comprises a retainer for holding a power attachment of at least one other heating source.

In an exemplary embodiment, each of the plurality of power sources comprises a power attachment extending through the respective frame of each of the power sources; and the power attachments of each of the plurality of heating sources are run in parallel from a power source.

In an exemplary embodiment, a method of providing heat may include providing a heating system; storing the heating system in a collapsed configuration; and deploying the heating system to a deployed configuration; and supplying power to the heating source of the heating system so that the heating source provides heat.

In an exemplary embodiment, the method may include storing the heating system in a collapsed configuration by wrapping the heating system in a housing and storing the heating system within the housing.

In an exemplary embodiment, the method may include deploying the heating system components from the housing by opening the housing and using a deployment device, such as a tether, to extend one or more of the heating sources from the housing.

### DRAWINGS

FIG. 1A illustrates an exemplary system part for providing heat according to an embodiment of the present disclosure.

FIG. 1B illustrates an exemplary heating system according to an embodiment of the present disclosure in which the component of FIG. 1A is a part.

FIG. 2 illustrates exemplary component parts in an exploded view for a portion of heating system according to embodiments of the present disclosure.

FIG. 3-7 illustrates exemplary system components in various stages of assembly for providing heat according to embodiments of the disclosure.

FIG. 8 illustrates an exemplary heating system having a housing according to embodiments of the present disclosure.

FIGS. 9A-9B illustrate an exemplary heating system in a stowed configuration of FIG. 9A and an expanded configuration of FIG. 9B.

FIGS. 10A-11 illustrate an exemplary heating system and component parts according to embodiments of the present disclosure.

FIGS. 12-14 illustrate exemplary housing components of the heating system according to embodiments described herein.

FIG. 15 illustrates an exemplary system having a deployable structure in which exemplary embodiments of the heating system are coupled thereto.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. The drawings are diagrammatic and schematic representations of exemplary embodiments of the invention and are not limiting of the present invention nor are they necessarily drawn to scale.

Exemplary embodiments described herein include a heating system for providing heat to a system environment or system part(s). Exemplary embodiments described herein may include a heating source for providing heat, a frame for protecting the heating source, a tether to manage deployment of the heating source, power attachment to power the heating source, and a combination thereof. Exemplary embodiments may also include a retainer for retaining the power attachments and cords that may be used if a plurality of power sources is provided within the system according to exemplary embodiments described herein.

Exemplary embodiments described herein may include one or more heating sources as described herein. Exemplary embodiments with a plurality of heating sources may serially connect the heating sources or may connect the heating sources in parallel or a combination thereof. The coupled heating sources may create part or all of the heating system. Exemplary embodiments may provide benefits as understood to a person of skill in the art. Exemplary embodiments of the heating source may provide a small, compact, and efficient means to provide heat to a system part or system environment. Exemplary embodiments of the frame may provide protection for the heating source so that the system may be stored in a compact configuration and deployed to an extended configuration for use while protecting the heating sources. Exemplary embodiments may include deployment devices and power connection devices and other connectors to reduce strain on the heating source cords and power delivery sources and attachments. Exemplary embodiments of a storage housing may be configured to manage deployment, further protect the heating sources, and reduce tangling of cords and deployment devices, among others. The exemplary features are provided as examples only and are illustrated for convenience together to create a heating system. However, any combination of features may be used in any combination. No individual feature, benefit, or function is essential to the device or its operation. For example, the housing described herein, may even be used with other serially connected system components for compact retention and efficient deployment to manage cord, tethers, strings, or other component parts that may tangle or entwine or otherwise interfere with deployment. A person of skill in the art would also appreciate that additional or alternate benefits may also be realized by exemplary embodiments described herein.

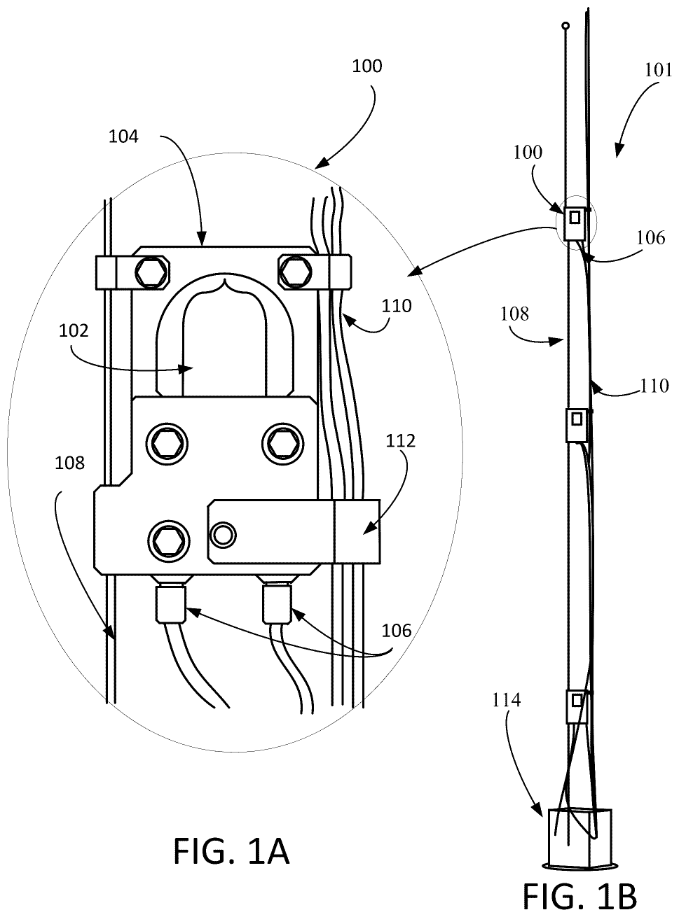

FIG. 1A illustrates an exemplary system part for providing heat according to an embodiment of the present disclosure. The heating system part 100 may include a heating source 102, a frame 104, power attachment 106, deployment device 108, power cords 110, and retainer 112. Exemplary embodiments of the systems and methods for providing heat described herein may include any combination of the following benefits:
provide a desired amount of energy, such as, for example at least 110 watts, at least 150 watts, or between 110 to 200 watts, or a combination thereof;
provide a small form factor;
permit a long self-life (such as on the order of months or years);
provide mechanical harness connections to relieve wire strain;
provide electrical harness connections for parallel circuit for redundancies;
permit a low packing factor for compact storage;
permit expansion into a use configuration;
stowable and deployable; and
permit wire management to reduce or eliminate tangling of wires during deployment.

Exemplary components parts may be used to provide any combination of benefits. For example:
a frame in combination with system components such as the deployment device may be configured to provide deployment separate from the power cords to reduce strain on system components;
a frame configured to provide protection around one or more heating elements;
a housing for system storage;
a storage/deployment configuration of the heating system;
features to relieve stress on the system components including strain relief on power cords;
retention of the cords near the respective frames for cord management and reduce tangling; and
any combination thereof.

Exemplary embodiments may include any combination of features and/or components as described herein. No feature or combination of components are necessary, but instead any combination of features may be used, removed, added, duplicated, or recombined and remain within the scope of the present disclosure. For example, a first configuration may include a heating source, deployment device, and frame, but not the retainer and/or attachment devices. As another example, a second configuration may include a heating source and deployment device. The exemplary configurations may include different combinations of a housing as described herein. Some configurations of the housing may provide protection to the heating source, others may provide attachment for the deployment device for pulling and moving the heating device to a desired position or deployed configuration, while others may provide both benefits. Optional embodiments may include retainer(s), and/or different configurations of cords, connectors, etc. as described herein.

In an exemplary embodiment, the heating source 102 may be configured to generate and/or radiate heat. As illustrated the heating source 102 is a bulb. In an exemplary embodiment, the bulb is a halogen bulb. In an exemplary embodiment, the heating device may be approximately 110 to 200 watts, although other power ranges are also included. In an exemplary embodiment, the heating device provides more than 110 watts of energy or more than 150 watts of energy. Ither bulbs or heating sources are also within the scope of the instant disclosure. For example, resistance heaters, incandescent light bulb, light-emitting diodes (LED) s, and other heating devices.

In an exemplary embodiment, frame 104 may be configured to protect the heating source 102. In an exemplary embodiment, frame 104 may fully or partially circumscribe or surround the heating source. As illustrated, frame 104 comprises a body having an opening therein. The heating source may be positioned within the opening. As illustrated, the frame may enclose the heating source, such that the frame may be positioned on each of the two-dimensional sides of the heating source. The frame may be configured to be positioned on each of the three-dimensional sides of the heating source. For example, extensions may be provided extending from the frame in front and behind the heating source. As illustrated, the frame is positioned on a top, bottom, and opposing sides of the heating source. The directions described herein are relative to each other, and do not necessarily dictate an absolute direction in gravitational or worldly space. It is understood that top or up is opposite down or bottom, while sides are on generally perpendicular faces from the up and down, and opposing sides are on opposite faces.

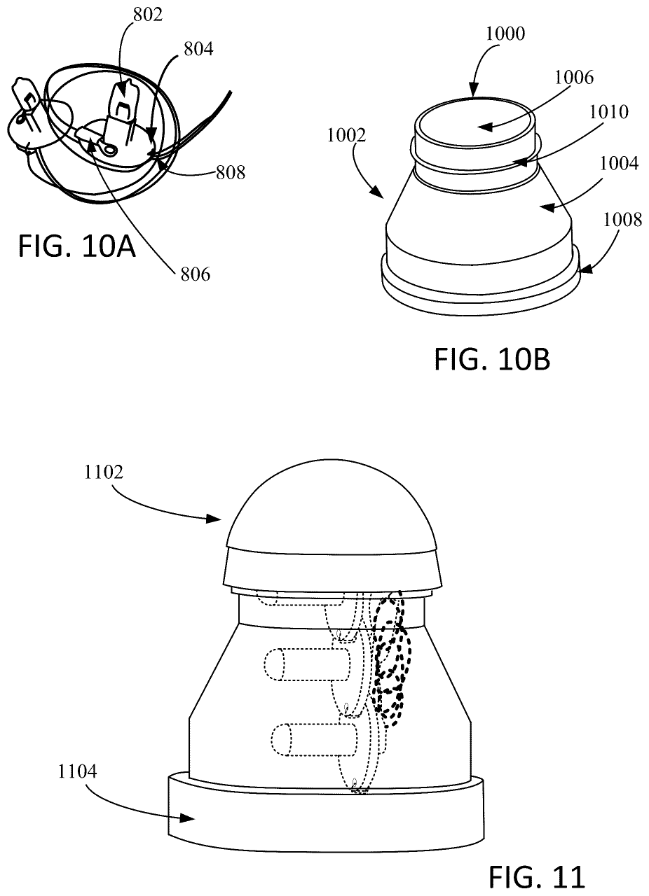

In exemplary embodiments, such as those shown more clearly with respect to FIG. 10A, frame 104 may be configured to attach to deployment device 108. The configuration between the deployment device 108 and frame 104 may be configured such that the deployment device is statically attached to the frame, in which case the frame does not translate or move along the tether of the deployment device. The frame may therefore be configured so that the deployment device can impose a pulling force on the heating system part 100 while minimizing strain imposed on the cords and connectors to the heating source itself.

In an exemplary embodiment, the deployment device 108 is configured as a tether to assist in deployment of the heating source 102 such as by providing a conduit to apply force to the heating device, such as through its frame in order to move the heating device. As illustrated, the tether 108 is a cable that is statically attached to the frame. The tether 108 may be pulled or extended to deploy the heating source to a deployed configuration from a stowed configuration.

In an exemplary embodiment, the power attachment 106 may be configured to provide power to the heating source 102, such as by permitting attachment of cords to the heating source. The power attachment, by itself, and/or in combination with other components described herein may provide strain relief. For example, the power attachment may be configured with a strain relieve protective covering. As another example, the power attachment may include one or more attachment components, as described herein, to provide a secure attachment between the heating source and the wires to provide power to the heating source.

In an exemplary embodiment, the retainer 112 may be configured to collect, retain, and/or otherwise manage by positioning one or more cords, tethers, power attachments, etc. from the heating system part 100 and/or one or more other heating source(s) or of other system components as described herein.

In an exemplary embodiment, the retainer 112 may attach to the frame 104. The retainer may couple to or be positioned to hold or fully or partially surround the frame and/or one or more other system components 110. For example, the retainer may be configured to retain one or more cords, power attachments, tethers, or combinations thereof as described herein. As illustrated, the retainer may be a loop, aperture, ring, housing, holder, or a combination thereof. As illustrated, one or more other components may pass through but confined by portions of the retainer. In an exemplary embodiment, the retainer and the frame may define an enclosed perimeter in which the one or more other components may pass through or be positioned therein. In an exemplary embodiment, one or more cords may slidably pass through an enclosure defined by the retainer and frame, such that the cords are confided within a perimeter circumferentially but permitted to pass through longitudinally. In other words, the frame and retainer may slide along the one or more cords positioned within the retainer.

In an exemplary embodiment, one or more components attached to the frame (either directly or indirectly) may be configured to statically attach so that the one or more components attached to the frame are not permitted to move relative to each other at the point(s) of attachment. For example, the tether may be coupled to the frame so that a pulling force applied to the tether may translate to the frame and movement of the tether will move the frame as at the attachment point between the tether and the frame, the tether is not configured to move relative thereto. In an exemplary embodiment, the attachment may be through a friction fit, compression attachment, ring, binding, adhesion, etc. Other attachments to the frame may similarly position one component part to the frame so that the component part at the point of attachment (whether direct or indirect) does not move relative to the frame. For example, retainer 112 may provide such a rigid attachment configuration. In this configuration, the length of cords between adjacent frames may be greater than a length of tether of the deployment device such that the deployment device takes the strain of deployment over the cords. In other words, the tether may be under tension to impose a force along its length to the respective heating system parts 100, while the cords between adjacent frames remains slack or not under tension.

In an exemplary embodiment, the attachment between component parts to the frame may permit relative or limited movement between the coupled parts. In this case, the connection may provide limitations on movement between the component parts but may also permit relative or limited movement therebetween in other directions. For example, the retainer may encircle component parts to retain the component parts that may include cords, for example, to the frame, but may permit the cords to slide or pass through the retainer. The retainer may therefore be configured to limit relative movement of the chords away from the frame in a first direction but may permit movement of the chords along the frame in a second direction. The first and second directions may be perpendicular to each other.

Exemplary embodiments described herein may include a system for providing heat, wherein the system comprises a heating source; a frame; and a tether coupled to the frame. In an optional configuration, the frame may be positioned around at least a portion of the heating source. The system may include a plurality of heating sources, wherein each heating source comprises a frame, and the tether coupled to each of the frames of the plurality of heating sources. Each of the heating sources may be separated along the tether in a deployed configuration.

FIG. 1B illustrates an exemplary heating system 101 comprising a plurality of heating system parts 100 positioned along a deployment device 108. The system may comprise a housing 114 configured to retain components of the heating system in a collapsed configuration.

As illustrated, a mechanical harness (including, for example, the tether) may be deployed in which the heating system parts including the heating source(s) 102 may be coupled thereto and brought out of and/or away from the housing 114 to transition the heating system from a collapsed or stowed configuration to an extended or deployed configuration. Exemplary embodiments of the system may include electrical harnesses and/or connections to reduce the strain on the electrical connections to the heating source(s). In an exemplary embodiment, the plurality of heating sources may be positioned at specific distances relative to an adjacent heating source. The distances may be the same or different. The distances may be set relative to other system components that require heating, such as joints or deployment elements of another structure. In an exemplary embodiment, the electrical connections between the heating sources may be run in parallel to provide redundancy to the system and/or permit one or more heating elements to continue to operate in the event of failure of one or more other heating elements. In an exemplary embodiment, the retainer may be configured to retain the power cords to the one or more other heating elements for cord management and reduce tangling.

In an exemplary embodiment, a power source (not shown) may be positioned at or within housing 114. The power source may be, for example, a battery. The power source may include one or more power cords that extend between and couple to the one or more heating sources and/or the power source. In an exemplary embodiment, each heating source has its own power cords coupled between the heating source and the power source. In an exemplary embodiment, a subset of heating sources are coupled in series such that a single set of power cords extend between the power source and the subset of heating sources so that a first set of course extend from the power source to a first heating source then from the first heating source to a second heating source and so forth through the subset of heating sources. Another subset of heating sources may similarly be coupled in series from the power source through each of the other subset of heating sources. The system may therefore comprise a first subset of heating sources serially coupled to the power source and a second subset of heating sources serially coupled to the power source. The first subset of heating sources and the second subset of heating sources may be coupled to the power source in parallel. The system may have any combination of heating sources coupled in series and/or in parallel and remain within the scope of the present disclosure. For example, all of the heating sources may be serially linked to the power source; all of the heating sources may be linked in parallel to the power source. Any combination of subsets, including, one, two, three, or more subsets of heating sources may be serially linked within each subset and linked in parallel between each subset. Each subset may contain the same or different number of heating sources. The different subsets may be coupled to the same or different power sources.

FIG. 1A illustrates a single strand configuration in which a plurality of heating sources is coupled together along the length of a single deployment device 108. Other configurations are within the scope of the instant disclosure. For example, two or more deployment devices may be coupled to different strands of heating sources so that the heating strands may be deployed in different directions and/or configurations. As would be understood by a person of skill in the art, the different strands may be repeated versions of the embodiments as described as the single strand configuration of FIGS. 1A-1B.

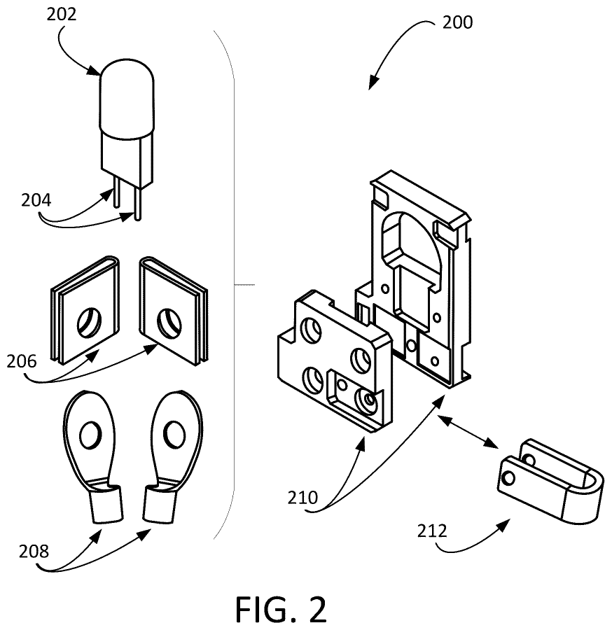

FIG. 2 illustrates exemplary component parts in an exploded view for a heating system part for use in a heating system according to embodiments of the present disclosure.

In an exemplary embodiment, the heating system part 200 may comprise a heating source 202 having power connectors 204 coupled thereto. The power connectors 204 may permit connections of component parts, such as cords, strain relief components, re-enforcement, etc., to couple the heating source 202 to a power source (not shown). As illustrated, the power connectors 204 may comprise wires and/or posts. As illustrated, the heating source 202 is a light source, such as a halogen light. The heating source may be any heating element, such as a resistance heating element, light bulb, halogen bulb, etc. Resistive heating elements may include metallic alloys, ceramic materials, and/or ceramic metals.

Exemplary embodiments of the heating source may comprise heating element(s) including a filament material used for electrical heating enclosed within an enclosure of glass, quartz, or other casing. The heating source may include one or more gases within the enclosure. Exemplary embodiments of filament materials may include tungsten wire, carbon, alloys of iron, chromium, aluminum, and combinations thereof. Exemplary heating elements may include any combination of ceramic, PTC (positive temperature coefficient), aluminum, wire, quartz, metals, carbon, and a combination thereof. Exemplary gases may be inert gases, halogen gases, argon, nitrogen, iodine, and/or bromine, but may include other gases as well. In an exemplary embodiment, the heating element may be a tungsten filament housed in a quartz capsule that is filled with iodine and bromine gases. Exemplary heating source may be devices and/or materials in which electrical energy is converted into heat or thermal energy. These may include materials that cause friction to electric current that results in heat within the conductor. These devices may be configured as coils, ribbons, stripes of wire or other configurations. Exemplary materials may include nickel-based or iron-based alloys.

In an exemplary embodiment, the heating system part 200 may comprise a power attachment mechanism. The power attachment mechanism may provide strain relief to the attachment of the power source (not shown) to the heating source, such as at power connectors 204. The power attachment mechanism may also or alternatively provide a secure connection of the power source to the heating source. The power attachment mechanism may provide re-enforcement for the connection.

In an exemplary embodiment, the power attachment mechanism may comprise a connector 206 and terminal 208 for each power connector 204 of the heating source. As illustrated, connector 206 comprises a plate that is configured to contact the power connector 204 of the heating source. As illustrated, each connector 206 comprises a first plate and a second plate wherein the power connector of the heating source is configured to be positioned therebetween. The first plate and second plate are attached to each other through a fold over portion. The connector 206 may extend over a majority (more than 50%), a substantial majority (more than 75%), or approximately all of the power connector 204 of the heating source. Connector 206 may be configured to provide rigidity and support to the power connector 204 of the heating source to reduce stresses at the attachment point of the connector and the heating source. In an exemplary embodiment, terminal 208 comprises a plate configured to be positioned within the plates of connector 206. The plate of the terminal is configured to be in contact with the plates of connector 206. The plates create a rigid attachment and improved attachment area in contact between the component parts to reduce stresses at the attachment locations and improve electrical transfer therebetween. As illustrated, the plate of connector 206, and the plate of terminal 208 comprises apertures configured to align and permit attachment therethrough. The attachment may be through screws, rivets, etc. The housing, defining the frame, may comprise similar apertures for connection therebetween as will be described in more detail herein. As illustrated, the terminal may also include an attachment end for coupling to a cord that may be coupled to a power source. The attachment end, as illustrated, may comprise a collar for securely attaching a cord therein. The collar may be configured to be crimped onto the cord. The collar may be configured to be soldered onto the wire. The collar may be coupled to the cord in any combination of methods. In an exemplary embodiment, the power attachment mechanism may include other combination of strain relief features, such as coverings, coatings, collars, springs, etc. In an exemplary embodiment, the connector comprises a copper plate and the terminal comprises a conductive metal.

When assembled, the power connector 204 is positioned on an inside edge of the connector 206 so that the power connector 204 does not interfere with the aperture through a central area of the connector. The terminal 208 is also positioned in contact with and between the connector 206 so that the apertures of the connector 206 and the terminal 208 are generally aligned. The power connector 204, connector 206, and terminal 208 are therefore in electrical contact with each other. The sandwiched power attachment mechanism may then be positioned between respective sides of a housing 210.

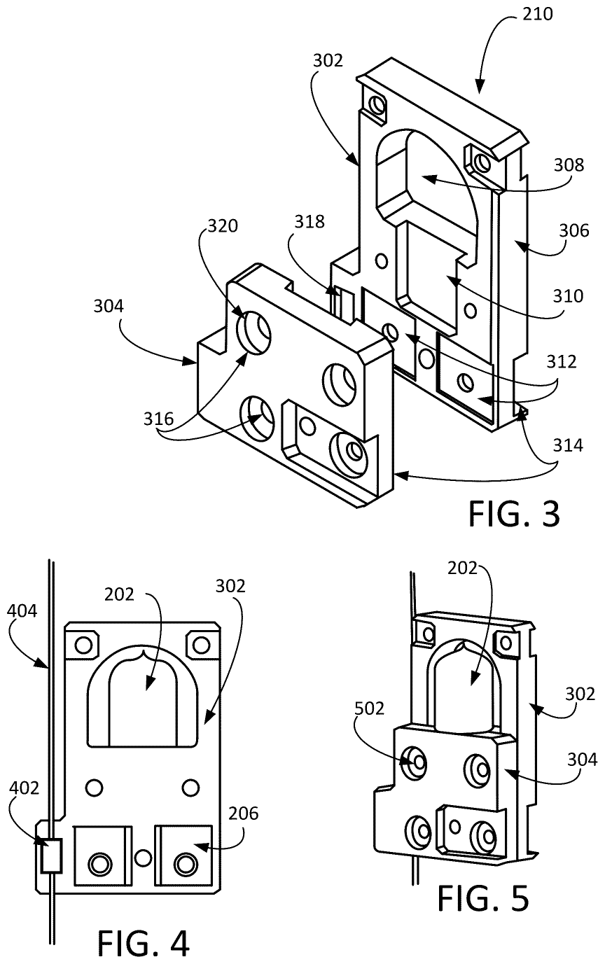

FIG. 3 illustrates an exemplary frame 210 component according to embodiments described herein. As illustrated, a housing is provided to define a frame for the heating system part. The frame 210 may comprise a first housing 302 and a second housing 304. The first and second housings may be coupled together. As illustrated, one or more apertures 320 may be provided to couple the first housing to the second housing. The housings may be coupled together through screws, rivets, press pins, rods, mated surfaces, snaps, etc.

As illustrated, the first housing 302 may comprise a frame body 306. The frame body may be configured to provide protection to the heating source. The frame body may comprise a rigid structure configured to be positioned on at least one side, on at least two sides, on at least three sides, on at least four sides, on at least five sides, and/or on at least six sides of the heating source. As illustrated, frame 306 is configured to be positioned on four sides of the heating source to enclose the heating source. Frame 306 may have an aperture 308 therein to position at least a portion of the heating source therein. The aperture may permit the heating source to be positioned therein and reduce interference with the heating ability of the heating source to reach elements proximate thereto.

As illustrated, the housing may comprise one or more indentations to accommodate component parts as described herein. For example, a first indentation 310 may be configured to position and retain a portion of the heating source, second indentations 312 may be configured to position and retain the electrical connectors, third indentations 314 may be configured to retain or accommodate a portion of a connector bracket, retainer, cable clamp, loop, retention mechanism, and fourth indentations 316 may be configured to accommodate attachment mechanisms such as screws, rivets, snaps, etc. to permit the component parts to fit within the housing to create flush surfaces to reduce tangling and/or facilitate storage, deployment, or a combination thereof, and a fifth indentation 318 may be to create or accommodate a mechanical harness (such as a sleeve) for holding the tether to assist in deployment of the housing.

FIGS. 4-7 illustrate exemplary system components in various stages of assembly for providing heat according to embodiments of the disclosure.

FIG. 4 illustrates a first side of the housing 302 having positioned therein a heating source 202 coupled to the connectors 206 within the respective aperture, and indentations of the housing body. The system also includes the tether 404 retained by a sleeve 402.

In an exemplary embodiment, the sleeve 402 is configured to couple the tether 404 to the frame when the housing is coupled together. The sleeve may be configured to rigidly couple the sleeve to the housing so that relative movement is not permitted therebetween. The connection may be through mated surfaces between the sleeve and the housing, such as the indentations of the housing described herein. In an exemplary embodiment, the sleeve may be slidably coupled to the tether in a formation configuration and may be rigidly coupled to the tether in a deployment configuration. For example, during manufacturing, the sleeve may slide along the tether to position the heating sources (or the frame) at desired locations along the tether. The sleeve may then be crimped onto the tether so that the sleeve is retained in the same location relative to the tether and does not permit relative motion between the tether and the sleeve at the attachment point. The uncoupled portion of the tether may still move relative to the frame.

FIG. 5 illustrates the attachment of both sides of the housing to define a frame around the heating source and enclosing the electrical connections to the heating source. As illustrated, the portions of the housing, the first housing 302 is coupled to the second housing 304 with screws 502.

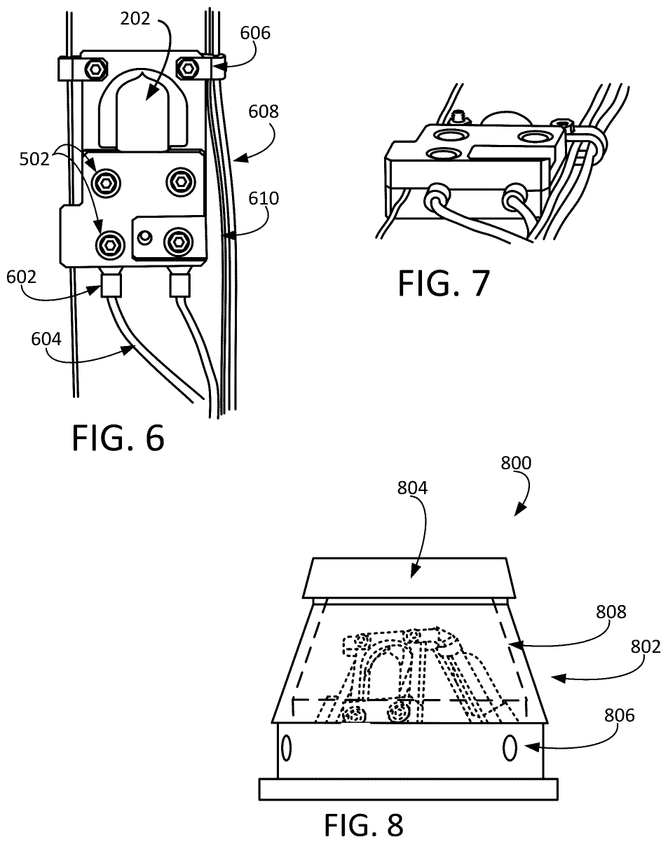

FIG. 6 illustrates addition connections with screws 502. As illustrated, electrical connections comprising cables 604 and terminals 602 can be inserted through apertures in the bottom of the housing (see FIG. 7) and retained in position with additional screws 502. Also illustrated are additional cable clamps 606 retaining system components including additional power cords 610 to power sources (not shown) and other heating sources and other heating system parts, and/or other system cables 608.

FIG. 7 illustrates a bottom view of the heating system part. As illustrated, the system part comprises a rigid connection between the frame and the tether but may provide a moveable or slidable connection between the frame and other system components, such as cables, etc. to other system parts including other heat sources.

In an exemplary embodiment, the heating system described herein may include a housing, such as housing 114, illustrated in FIG. 1B. The system housing may provide an enclosure, for securing and retaining system components in a stored configuration.

FIG. 8 illustrates an exemplary enclosure 800 for retaining a plurality of heating system parts, including heating sources as described herein, power, cables, deployment device, etc. FIG. 8 comprises a housing 802 with a first portion 804 of a housing and a second portion 806 of a housing. The housing 802 may include a cavity 808 illustrated by dashed lines. The cavity 808 may contain the system components therein as indicated by the dashed outline of the system components of an exemplary heating system. In an exemplary embodiment, the housing 802 may include a first portion 804 and second portion 806 may be removably attachable to each other to define a stowed configuration of the system and an open configuration in which portions of the heating system, including, for example, the heating sources, may be extended from the cavity in a deployed configuration.

The housing may comprise an exterior enclosure 800 configured to retain portions of the heating system therein. The exterior enclosure may be configured to protect system component parts during storage. The exterior enclosure may be configured to maintain the system in a stored configuration. The exterior enclosure may be configured to house the system component parts in a desired configuration. The exterior enclosure may therefore comprise one or more walls defining a cavity therein.

The enclosure may comprise an interior cavity configured to retain portions of the heating system thereon. The interior cavity may be configured such that portions and/or component parts of the heating system are configured to be positioned or retained in a desired configuration on a surface of the interior enclosure. The interior enclosure may comprise one or more walls, surfaces, projections, etc. for supporting component parts thereby.

In an exemplary embodiment the enclosure 800 may include alternative designs, configurations, and/or component parts to retain the heating system parts in a desired configuration. Exemplary embodiments may use system component selections and/or housing enclosure designs to maintain a desired stowed configuration and permit more efficient deployment, such as, for example, by reducing tangling of system parts during the transition from the stowed configuration to the deployed configuration.

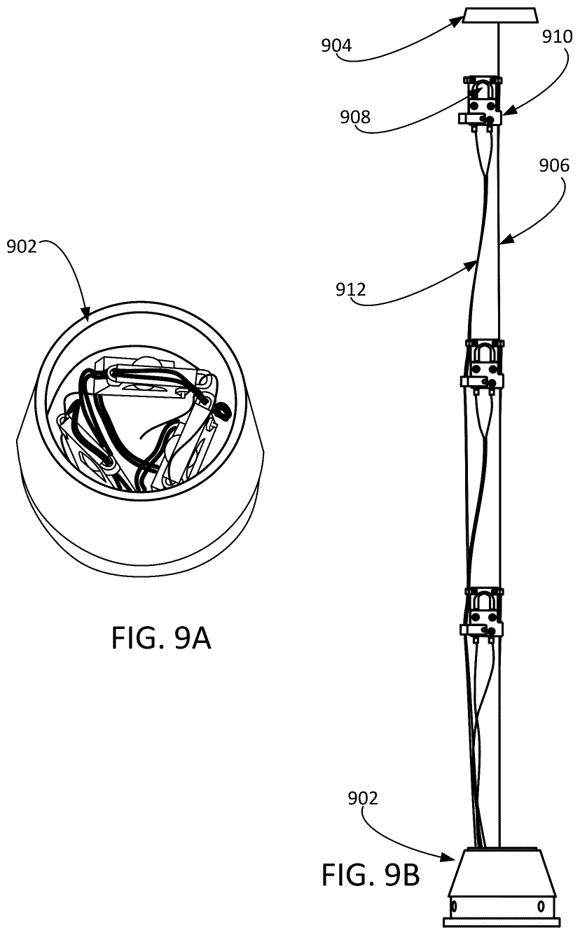

FIGS. 9A-9B illustrate an exemplary embodiment in which FIG. 9A illustrates an exemplary system configuration in a stowed configuration with the top of the housing removed for illustrative purposes, and FIG. 9B is in a deployed configuration.

As illustrated in FIG. 9A, the housing 902 may include a tapered wall to define a portion of a cone. The tapered wall may be used to retain the heating source frames in a desired configuration. In an exemplary embodiment, the cords and/or tether, and/or other system components may be selected to have a desired rigidity so that they may be positioned in a stowed configuration and maintain a general position within the housing during storage. These components may also be flexible in that they may deform when transitioning from the stowed configuration to the deployed configuration.

FIG. 9B illustrates an exemplary embodiment in which the top 904 of the housing 902 is removed therefrom. The top 904 of the housing may be coupled to a deployable structure, such as, for example, a boom, wing, arm, etc. that may be deployed. The top 904 may be separated from the housing to pull the heating sources out from the housing 902.

In an exemplary embodiment, a deployment device 906, such as described herein, may be coupled between the first portion 902 of the housing and the second portion 904 of the housing. When the first portion and the second portion of the housing are separated and moved away from each other, using an exterior deployment device (not shown), the force necessary to extend the heating sources 908 from the housing are applied through the respective frames 910 of the heating system parts. During deployment, the power source connectors and cords are protected and strain limited as the deployment forces are focused on the deployment device 906 and frame 910.

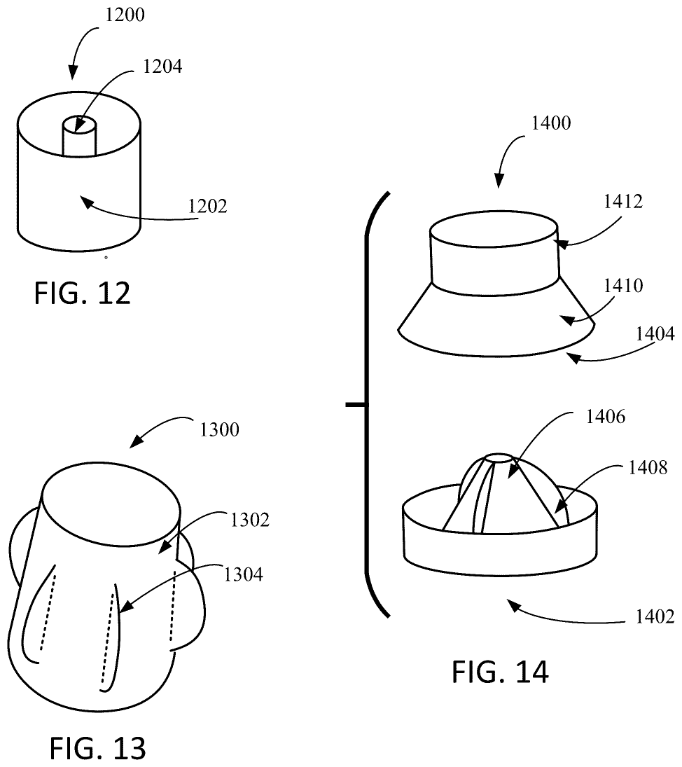

FIGS. 10A-10B illustrate an alternative configuration of the heating system part, including, the frame and heating source in FIG. 10A, and housing in FIG. 10B. FIG. 11 illustrates the exemplary embodiment of the heating system parts of FIG. 10A and 10B in an exemplary stowed configuration.

As illustrated, the heating source 802 may still be a heating element as described herein with respect to other embodiments. The heating source 802 may be coupled to a frame 804. In this example, the frame 804 is primarily designed to provide strain relieve to the connections of the heating source and provide a rigid structure to couple the deployment device 806.

As illustrated in FIG. 10A, an exemplary frame 804 may be generally disc shaped. The disc may permit the heating source to extend from a first side of the frame, and the connections between the heating source and the power source on an opposite side of the frame. An exemplary deployment device 806, a string tied to an aperture in the frame, is provided. The deployment device may be attached to the frame to apply a deployment force to the frame as the heating system extends from the stowed configuration to the deployed configuration.

FIG. 10B illustrates an exemplary housing for retaining the heating system components, such as those from FIG. 10A. As illustrated, the housing 1000 may include a main body portion 1002. The main body portion may include an exterior wall 1004, a bottom 1008 and an opening 1006. As illustrated, the exterior wall 1004 may be tapered such that the opening 1006 at the top of the housing 1000 defines a smaller diameter or cross section than the bottom of the housing. The tapered housing may assist in deployment of the system and reduce the extension of cords, tethers, and system components, until they are pulled out of the housing. This may reduce system components free and/or not under tension that may tangle or get caught up on other system components, thereby causing problems with full deployment.

In an exemplary embodiment, the housings may be separable and/or removably attach to each other. As illustrated in FIG. 10B, the housing may include a flange 1010 in which a lid or surface is compressed thereon so that a mated surface or friction fit is created therebetween. The lid may be retained on the housing through a dent/indent mated surface, flange, friction fit, etc.

FIG. 11 illustrates the exemplary heating system of FIGS. 10A-10B in a stowed configuration. As illustrated, the respective heating sources 802 are stacked within an interior cavity of a housing. The housing includes a removable lid 1102 from the bottom 1104 in which the heating system components may extend therethrough.

Exemplary embodiments of the housing may include any combination of other features that may be used to assist in the storage and/or deployment of system components.

FIGS. 12-13 illustrate exemplary housing component parts that may be used in any combination with other housing configurations described herein. FIG. 14 illustrates an exemplary configuration in which the features of FIGS. 12 and 13 may be applied to the configuration similar to FIG. 8.

FIG. 12 illustrates an exemplary housing 1200 in which the housing comprises an exterior housing 1202 that defines an interior cavity as described herein. The exterior housing 1202 is illustrated as a constant cylinder, but may include other shapes, such as the tapered cylinder (portion of a cone), as described herein. The exemplary housing 1200 may also include an interior surface 1204. The interior surface may provide a central separator that may assist in the packaging of system components during storage. For example, the interior surface 1204 may create a surface in which interior components, such as cords and/or heating sources, and/or frames may be wrapped around and maintain component positions relative to each other. As illustrated the interior surface 1204 is a constant cylinder, but may include other shapes, such as the tapered cylinder (portion of a cone) as described with respect to the exterior housing. The interior surface may correspond to a surface shape of the exterior housing or may be different therefrom. For example, both the interior surface and the exterior housing may have the same cross-sectional shape, may be constant (cylindrical) or may be tapered (cone or a portion thereof), or may be a combination thereof. The interior surface may be different from the exterior housing in that the interior surface is smaller to create a space between the interior surface and the exterior housing but may otherwise be similar thereto. The use of “similar” or other related terminology would be understood by a person of skill in the art to be that the surfaces are approximate to each other in one or more attributes, such as shape, slope, configuration, etc., but may deviate in another attribute, such as size, etc. The surfaces are similar if one represents or relates to the other in some attribute.

FIG. 13 illustrates an exemplary portion of a housing 1300 including an interior surface 1302. The interior surface 1302 may include functions and features as described with respect to the interior surface of the FIG. 12 exemplary embodiment. As illustrated, the interior surface 1302 may also include dividers 1304. The dividers may be extensions extending outwardly from the interior surface 1302 and spaced apart. The dividers may be sufficiently separated so that component parts of the heating system, such as, for example, the heating sources and/or frames, may be positioned therebetween. The dividers 1304 may be used to assist in the positioning, separation, and/or retention of components parts of the heating system described herein. Exemplary embodiments of the dividers may also include other retention features, such as clips, claws, protections, frictional contact, etc. that may further retain desired system components therein. In an exemplary embodiment, used in combination with or without the interior surface and/or the dividers, the cords and/or deployment device of the system may be sufficiently rigid to retain a desired position in the stored configuration so that the system may be used with or without the dividers.

FIG. 14 illustrates an exemplary housing 1400 in which the attributes of the housings described herein are put together in a different configuration. As shown, the housing 1400 includes a first portion 1402 that may be removably coupled to a second portion 1404. The first portion and second portion are configured differently such that the combination creates an interior cavity. The second portion may create all or a portion of the exterior wall as described herein or may simply be a lid structure and the exterior wall may extend from or be part of the first portion. The housing 1400 may include a tapered exterior wall 1410 that may be on either or both of the first portion 1402 and/or second portion 1404. The housing 1400 may include a lid or top portion 1412. The lid or top portion may be removable from the housing or may be a coping on the top of the housing. The housing 1400 may include an interior surface 1406. As illustrated, the interior surface 1406 may be tapered at a similar angle as the slop of the tapered wall 1410. The interior surface 1406 may have one or more dividers 1408 positioned thereon and extending outwardly therefrom.

In an exemplary embodiment the enclosure may be defined in two or more portions of a housing configured to mate together to define the interior cavity. For example, the interior cavity may be defined by a first surface having a core thereon to define the interior surface to support component parts, while the exterior enclosure configures one or more walls defining a cavity therein and having an opening providing access to the cavity. The interior enclosure, namely the first surface may be configured to fit in the opening of the exterior enclosure to act as a lid or closure surface to the opening. The exterior enclosure and interior enclosure may therefore mate to fully enclosure component parts of the heating system.

In an exemplary embodiment, the interior enclosure may comprise fins or other extensions extending outward from the core to separate component parts of the heating system and/or to assist in component placement and/or retention during storage and/or deployment.

In an exemplary embodiment, the core may comprise a cylindrical structure extending from the first surface. The cylindrical structure may comprise a constant cross-sectional shape. The cross-sectional shape may be circular, oval, ovoid, etc. The core may comprise a varying diameter. For example, the core may comprise a tapered structure that has a larger diameter proximate the first surface and a smaller diameter at a terminal end of the core away from the first surface.

In an exemplary embodiment, the exterior enclosure comprises a cylindrical structure. The exterior enclosure may comprise a first wall defining a perimeter of the exterior enclosure. The first wall may define a cylindrical shape. The cylindrical shape may comprise a constant cross section shape. The cross-sectional shape may be circular, oval, ovoid, etc. The exterior enclosure may comprise a tapered wall. For example, the first wall may taper from one end to another. The exterior enclosure may comprise a second wall defining a terminal, closing end to the first wall. In an exemplary embodiment, the first wall defines a first diameter proximate the second wall that is less than a second diameter of the first wall at the opening of the exterior enclosure at an end of the first wall opposite and away from the second wall.

Exemplary embodiments described herein include heating system parts. Exemplary heating system parts may include a heating source, frame, power attachment, and deployment device, such as a tether. The frame may or may not circumscribe the heating source. If the frame does not circumscribe the heating source, the frame may instead simply provide a base for the electrical connections of the heating source and the tether. This exemplary embodiment is configured to separate the power attachment from the tether and reduce strain on the power attachments. The frame also or alternatively circumscribes or be positioned on a plurality of sides of the heating source and provide protection to the heating source. The frame may be configured to not cover or provide substantial access to at least one or more sides of the heating source, such as, for example, two sides, so that the heat from the heating source may efficiently dissipate therefrom while still providing some protection to the heating source to permit stowage and deployment of the system.

As illustrated and described herein, different representative heating elements are positioned inside different exemplary frames inside or with different housing configurations for illustration purposes.

Exemplary embodiments of the housing may be configured so that a plurality of heating sources may be positioned therein. Each heating source may be positioned so that the power attachments and/or chords wrap around an interior surface of the exterior housing and heating sources are positioned adjacent the interior edge of the exterior housing. As shown and described herein, the exterior housing comprises an outer wall that is generally circular in cross section. The outer wall may be generally constant along its length to define a circular cylinder and/or may be tapered to define a circular cone or portion thereof. Other cross-sectional shapes are contemplated therein such as rectangular, square, ovoid, etc. The outer wall defines an interior cavity configured to position the heating sources and/or other system componentry. The outer wall includes a closed terminal end, as illustrated in FIG. 14, or may have an open terminal end as illustrated in FIG. 10B. If the outer wall has an open terminal end, the housing may include a lid or cap, such as illustrated in FIG. 11.

Exemplary housing configurations are provided herein. For example, an exemplary housing may include a wall, a first end closure and a second end closure. The wall circumscribes an exterior perimeter defining an interior cavity. As illustrated, the wall defines a first opening at a first end and a second opening at a second end opposite the first end. The wall may have a cross sectional shape having a variable diameter, constant diameter, or a combination thereof. The wall may define a cross-sectional shape, such as, for example, a circle, circloid, ellipsoid, ellipse, square, rectangular, etc. The wall may have a tapered section so that one end of the housing has a larger cross-sectional area than an opposite end having a smaller cross-sectional area. The first end closure and second end closure may be configured to cover the openings at the wall to create a full enclosure. The first and second end closure may be coupled to the wall in one or more ways. For example, the first end closure may be screwed onto the wall end, may be snapped on, may have mated surfaces such as detent/indent, may be frictionally fit, etc. As additional examples, the second end closure may be coupled through screws, pivots, pins, adhesive, or may be integrated or formed thereto, etc.

A method of providing heat is provided using exemplary embodiments of the heating system as described herein. Therefore, a heating system as described herein may be provided. The heating system may be stored in a collapsed configuration and may be deployed to a deployed configuration. Once deployed, the heating system may be turned on by supplying power to one or more of the heating sources described herein so that the heating source provides heat.

Exemplary embodiments of the method may also include storing the heating system by wrapping the heating system in a housing and storing the heating system within a housing. Deploying the heating system may include opening the housing and using the tether to extend one or more of the heating sources from the housing.

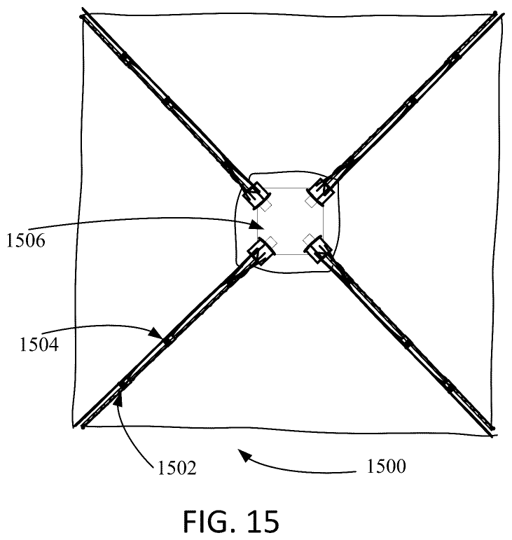

Referring to FIG. 15, exemplary embodiments of the tether may be coupled to another system component to extend the tether from the system 1500 collapsed configuration. The tether 1502 may be coupled to a deployable structure 1504, such as a boom, an inflatable structure, a telescoping structure, etc. In an exemplary embodiment, the deployment of the tether may be by applying a pulling force on the tether at one end thereof and retaining the other end of the tether, such as at the housing 1506, in a stationary position so that opposing ends of the tether extend away from each other. In an exemplary embodiment, the method of deploying the heating system may include applying a tension force to the tether while the spacing and/or attachment of the tether to frame and/or cords to frame are such that a tension is applied through the tether but tension is reduced (relative to the tether) in the cords. Therefore, the system is configured to reduce strain on the power cords during deployment.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

The invention claimed is:

1. A system, comprising:
a heating source;
a frame coupled to the heating source; and
a tether coupled to the frame.

2. The system of claim 1, further comprising a power attachment to the heating source and coupled to the frame, wherein the tether is coupled to the frame separate from the power attachment.

3. The system of claim 2, wherein the frame circumscribes the heating source to provide protection from more than one direction of the heating source.

4. The system of claim 3, wherein the frame comprises a generally planar component having an aperture therein, the heating source positioned within the aperture such that the frame circumscribes the heating source.

5. The system of claim 4, comprising a plurality of heating sources and a plurality of frames, wherein each of the plurality of heating sources each having its own respective frame from the plurality of frames, wherein the tether couples to each of the plurality of frames of each of the plurality of heating sources creating a link between the plurality of heating sources.

6. The system of claim 5, wherein each of the plurality of frames comprises a retainer for holding a power attachment of at least one other heating source.

7. The system of claim 6, wherein each of the plurality of power sources comprises a power attachment extending through the respective frame of each of the power sources; and the power attachments of each of the plurality of heating sources are run in parallel from a power source.

8. A method of providing heat, comprising:
providing a heating system of claim 1;
storing the heating system in a collapsed configuration;
deploying the heating system to a deployed configuration; and
supplying power to the heating source of the heating system so that the heating source provides heat.

9. The method of claim 8, wherein the storing comprising wrapping the heating system in a housing and storing the heating system within a housing.

10. The method of claim 9, wherein the deploying comprises opening the housing and using the tether to extend the heating source from the housing.
